(19) United States
(12) Patent Application Publication
(10) Pub. No.: US 2012/0140457 A1
(43) Pub. Date: Jun. 7, 2012

(54) WATERPROOF LENS SWITCH ASSEMBLY FOR PORTABLE LIGHTING UNIT

(76) Inventor: Shayne Laurence McQuade, New York, NY (US)

(21) Appl. No.: 13/306,945

(22) Filed: Nov. 29, 2011

Related U.S. Application Data
(60) Provisional application No. 61/458,906, filed on Dec. 6, 2010.

(51) Int. Cl. F21L 4/02; H01H 11/00; F21V 5/04

(52) U.S. Cl. 362/184; 362/235; 29/622

(57) ABSTRACT

A waterproof lens switch assembly for a lighting unit is provided. The waterproof lens switch assembly includes a cylindrical metal lighting fixture which includes a screwed-on ring, a protective lens, a transparent flexible cover, an electrical on/off switch and at least one LED lamp. The ring and the flexible cover together create a waterproof seal for the waterproof lens switch assembly. The transparent flexible cover and the clear lens both allow light to pass through, and the transparent lens protects the flexible cover. When depressed by a user, the lens pushes the flexible cover onto the on/off switch and turns the light on or off. The LED lamp illuminates when turned on, and provides illumination through the flexible cover and the lens, respectively.

### CROSS-REFERENCE TO RELATED APPLICATIONS

This application is claiming priority of U.S. provisional application Ser. No. 61/458,906, now pending. This application has the same inventor in common, namely, Shayne Laurence McQuade, with the aforementioned provisional application. The contents of the above-mentioned provisional application is hereby incorporated by reference herein in its entirety and made a part of this specification.

### FIELD OF THE INVENTION

The present invention relates generally to a light switch and in particular to a waterproof light switch that uses a lens of a flashlight or a hand-held electric-powered lighting unit itself to turn the light on and off, including high and low light levels.

### BACKGROUND OF THE INVENTION

Solar lighting systems use solar power to charge batteries. The batteries then power a plurality of light emitting diodes (LEDs) or some other lighting or illumination elements as needed. In many common usages, the solar lighting unit or portable solar lighting device will either be placed outdoors or otherwise subjected to rain and moisture. If the portable lighting unit is not completely waterproof, moisture will penetrate to reach the internal circuitry of the lighting unit, and the lighting unit will stop working. By making a solar lighting unit completely or substantially waterproof, it will have a longer lifespan, and be more useful to the end users.

Commercial waterproof flashlights are economically mass-produced. Most often, there is a tube or casing made of aluminum or other metal, with seals at the front end for the lens and at the back end for the power switch. If a flashlight or other cylindrical-shaped lighting unit is adapted for use as a portable solar lighting unit and connected to an external solar panel for electric power, the solar panel is easiest to connect at the back end of the portable lighting unit, opposite the end that houses the lens.

This solar panel power input then occupies the same location that is normally also occupied by an on/off switch for this type of portable lighting unit or device. Some flashlights have the on/off switches on the side of the barrel, but they are not waterproof. Other flashlights have bodies that twist for switching on/off, but this twist switching configuration may not provide complete waterproofing or make it difficult to adjust to a plurality of lighting levels. The lighting provided under the twist switching configuration is either on or off. The other problem with a twist switching configuration is that it requires two hands to operate by the user if the light is hanging. This creates the need for a novel design for a waterproof light switch.

### SUMMARY OF THE INVENTION

An object of the present invention is to provide a light lens that is both waterproof and functions as a switch to turn a portable lighting unit on and off. The lens is a clear lens that can made be of a thin plastic sheet of PVC, polycarbonate, or acrylic, glass or like material.

An aspect of the present invention is to create a transparent flexible cover such as a silicone cover and to integrate the transparent silicone cover with the lens to create a protective seal over the entire front end of the portable lighting unit. This creates a waterproof light switch through which a primary light source also shines or illuminates.

To turn the portable lighting unit on or off, the user presses the lens which sits on a flexible silicone cover or base, which in turn presses an electrical on/off switch residing on the circuit board underneath the silicone base or cover. The light can have multiple levels of lighting intensity, so that subsequent pushes of the on/off switch can make the light from the LED lamp become brighter before finally turning it off.

The light from an LED lamp shines through the transparent silicone cover and through the lens in that order, respectively.

Once secured in place with a threaded metal ring, the silicone base or cover forms a waterproof seal over the electrical on/off switch, the LED lamp, the battery case, and the rest of the circuitry.

The foregoing, as well as additional objects, features and advantages of the invention will be more readily apparent from the following detailed description, which proceeds with reference to the accompanying drawings.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout several views.

FIG. 1 shows an exploded view of a waterproof lens switch assembly according to an embodiment of the present invention;

FIG. 2 shows a top view of each component of the lens switch assembly of the embodiment of the present invention;

FIG. 3 shows a side view of the lens switch assembly of the embodiment of the present invention;

FIG. 4 shows the electrical on/off switch of the embodiment on the circuit board;

FIG. 5 shows an assembled on/off switch and LED lamp for the lens switch assembly of the embodiment; and

FIG. 6 shows a portable lighting unit using the lens switch assembly of the embodiment of the present invention.

### DESCRIPTION OF THE PREFERRED EMBODIMENTS

While the present invention is susceptible of embodiments in various forms, there is shown in the drawings and will hereinafter be described a presently preferred embodiment with the understanding that the present disclosure is to be considered an exemplification of the invention and is not intended to limit the invention to the specific embodiment illustrated.

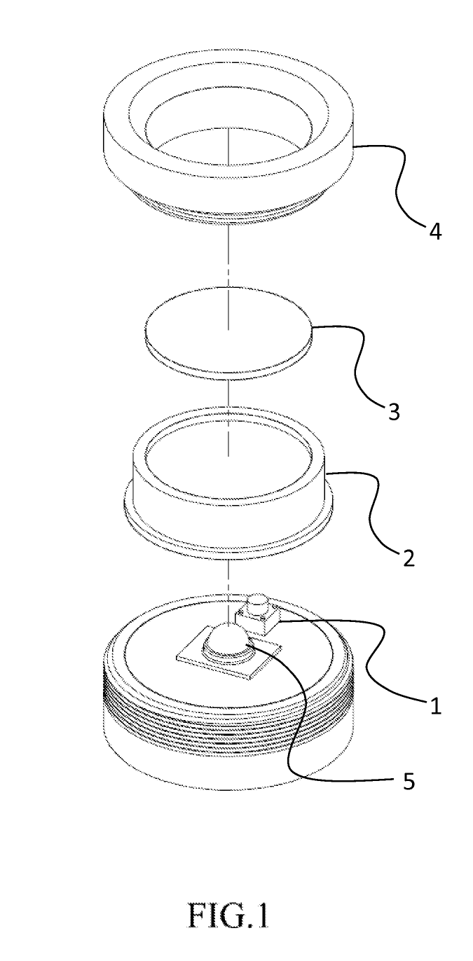

Referring to FIG. 1, a waterproof lens switch assembly includes a metal ring 4, a clear plastic lens 3, a transparent silicone cover 2, an on/off switch 1, and at least one LED lamp 5.

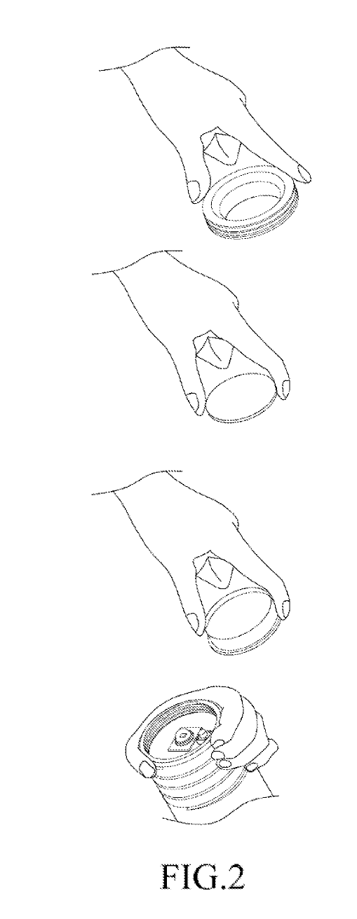

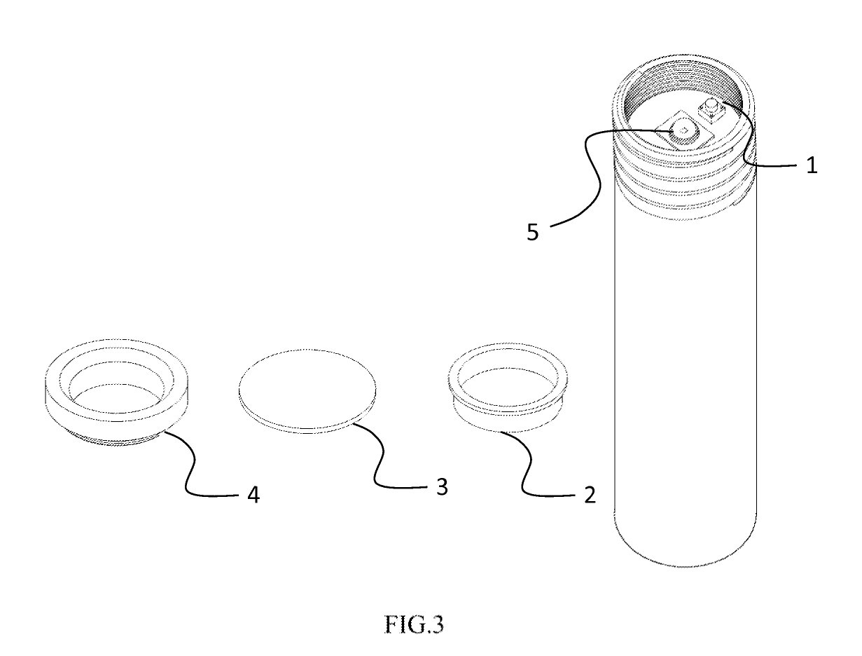

Referring to FIGS. 1, 2 and 3, the metal ring 4 is threaded on an inner portion of the metal ring 4, and screwed onto a base of a portable lighting unit. In this embodiment, the base of the portable lighting unit includes one or more batteries to store the electric power to light the LED lamp 5. In other embodiments, the base could connect directly to another electric power source, such as the electrical grid or an external battery.

Beneath the metal ring 4 is the plastic lens 3 that is round, thin, and clear in the present embodiment. This lens 3 is scratchproof and protects the silicone cover 2 and the internal circuitry. Since the silicone cover 2 is transparent, light illuminated from the LED lamp 5 substantially passes through it.

Beneath the metal ring 4 is also the silicone cover 2, which is molded. The silicone cover 2 creates a waterproof seal when lightly compressed by the metal ring 4 and the plastic lens 3. The center of the silicone cover 2 is designed to move down towards the on/off switch 1 when force is applied to the silicone cover 2 on the front side, and the silicone cover 2 returns back to its original relaxed state and shape, thereby moving away from the on/off switch 1 when the force is removed.

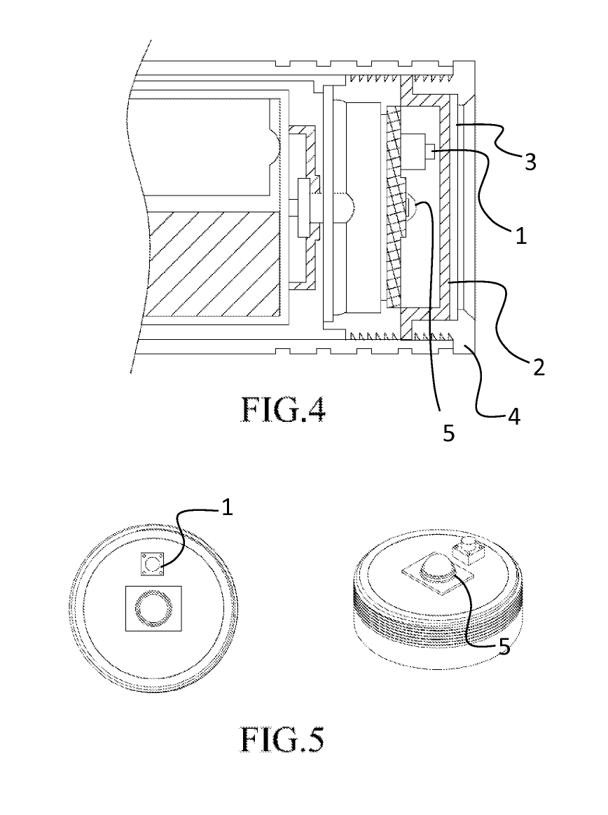

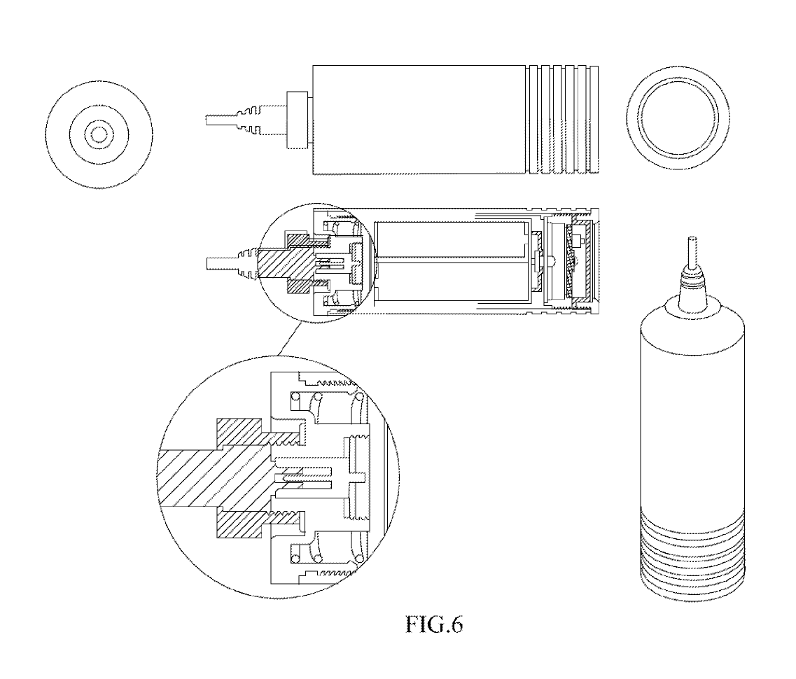

Referring also to FIG. 4, the electrical on/off switch 1 is a small component that turns the LED lamp 5 on and off when the switch 1 is pressed. In another embodiment, the switch 1 can also be configured with additional electronics or circuitry so as to provide multiple “on” levels of varying lighting intensity or brightness.

The LED lamp 5 is connected to an internal battery pack or other power source via a plurality of wirings.

Referring to FIGS. 1˜6, the waterproof lens switch assembly is assembled by an assembly method as described in the following steps.

Step 101: a clear plastic lens 3 is mounted on a transparent silicone cover 2.

Step 102: the clear plastic lens 3 and the transparent silicone cover 2 together are firmly inserted and attached into a base of the portable lighting unit.

Step 103: a threaded metal ring 4 is screwed onto the base of the portable lighting unit with the lens 3 and silicone cover 2 beneath the metal ring 4.

To turn on the light of the portable lighting unit, a user would press on the plastic lens 3, thus depressing also the silicone cover 2 and the electrical on/off switch 1, respectively. The LED lamp 5 would then turn on. After pressing the lens 3, the transparent silicone cover 2 would return to its original shape. Pressing the lens 3 again would again also depress the silicone cover 2 and the electrical on/off switch 1, respectively, and this time turning the LED lamp 5 off. In another embodiment, activating the on/off switch 1 consecutively or sequentially would make the light intensity of the LED lamp 5 higher until a maximum preset brightness or “on” level has being reached. A third or a fourth activation of the on/off switch 1, for example, can be required to turn the light off.

The metal ring 4 described above in the embodiment is one example, and the ring 4 can be made of other materials as well, such as metal alloy, ABS molded plastic, or the like. The clear plastic lens 3 can made be of a thin plastic sheet of PVC, polycarbonate, or acrylic, glass or like material. The transparent silicone cover 2 can be of tacky or non-tacky surface finish on either sides. The on/off switch 1 can be, for example, a small push button canopy on/off SPST switch for facilitating simple on/off switching capability, or a push button multi-level dimmer switch for facilitating multiple levels of lighting intensity for the portable lighting unit, thereby achieving more complex and versatile lighting capability. The LED lamp 5 can be, for example, a phosphor-based white LED lamp, or a super-white LED (GaN/InGaN) lamp from about 100 milliwatts to 120 milliwatts, for example.

FIG. 6 shows a portable lighting unit using the waterproof lens switch assembly of the embodiment of the present invention.

In the embodiments, the plastic lens 3 becomes part of the overall switching on/off system for the lighting unit so as to allow the actuating of the on/off switch 1. In addition, light shines through the switching on/off system, that includes the transparent silicone cover 2 and the plastic lens 3.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A waterproof lens switch assembly for a lighting unit, comprising:
a ring;
a clear lens;
a transparent flexible cover;
an on/off switch; and
at least one LED lamp,
wherein the ring is threaded on an inner portion thereof, and is screwed onto a base of the lighting unit, the clear lens is scratchproof, and the transparent flexible cover is transparent for allowing a substantial amount of light illuminating from the LED lamp to pass through.

2. The waterproof lens switch assembly as claimed in claim 1, wherein the base of the lighting unit comprising one or more batteries or is connected directly to an external electric power source

3. The waterproof lens switch assembly as claimed in claim 2, wherein the external electrical power source is an electrical grid or an external battery.

4. The waterproof lens switch assembly as claimed in claim 1, wherein when a force is applied to the transparent flexible cover on the front side, the center of the flexible cover is moved downward towards the on/off switch, and when the force is removed, the flexible cover returns back to its original relaxed shape, thereby moving away from the on/off switch.

5. The waterproof lens switch assembly as claimed in claim 1, wherein the electrical on/off switch is configured to have a plurality of circuitry to provide multiple “on” illumination levels of varying lighting intensity.

6. The waterproof lens switch assembly as claimed in claim 1, wherein the number of the ring is one, and the ring is made of a metal alloy or an ABS molded plastic, or other rigid material, and the ring is screwed, clipped, or held in place to exert pressure on the flexible silicone seal.

7. The waterproof lens switch assembly as claimed in claim 1, wherein the clear lens is made of a thin plastic sheet of PVC, polycarbonate, acrylic, glass or other rigid transparent material.

8. The waterproof lens switch assembly as claimed in claim 1, wherein the transparent cover is silicone, PVC, or other flexible transparent material.

9. The waterproof lens switch assembly as claimed in claim 1, wherein the on/off switch is a push button canopy on/off SPST switch or a push button multi-level dimmer switch.

10. The waterproof lens switch assembly as claimed in claim 1, wherein the LED lamp is a phosphor-based white LED lamp or a super-white LED (GaN/InGaN) lamp.

11. An assembly method for assembling a waterproof lens switch assembly, comprising:
mounting a clear plastic lens on a transparent silicone cover;
inserting the clear plastic lens and the transparent silicone cover together and attaching the clear plastic lens and the transparent silicone cover into a base of the portable lighting unit;
attaching via screwing a threaded metal ring onto the base of the portable lighting unit with the plastic lens and the silicone cover beneath the metal ring or via clipping the ring into place to exert pressure on the silicone cover and creating the waterproof seal.

12. A lighting unit, comprising:
one or more battery;
a housing; and
a waterproof lens switch assembly, comprising:
a metal ring;
a clear plastic lens;
a transparent silicone cover;
an on/off switch; and
at least one LED lamp;
wherein the metal ring is threaded on an inner portion thereof, and is screwed onto a base of the lighting unit, the clear plastic lens is scratchproof, and the silicone cover is transparent for allowing a substantial amount of light illuminating from the LED lamp to pass through.

13. The lighting unit as claimed in claim 12, wherein upon a user pressing on the plastic lens, the silicone cover and the electrical on/off switch are depressed, respectively, and the LED lamp then is turned on; and upon another pressing on the plastic lens by the user, the silicone cover and the electrical on/off switch are depressed again, respectively, and the LED lamp 5 is turned off.

14. The lighting unit as claimed in claim 12, wherein upon a user pressing on the plastic lens sequentially for activating the on/off switch, the light intensity of the LED lamp is then higher until a maximum preset brightness has being reached, and a final activation of the on/off switch is required to turn the LED lamp off.
